(19) United States
(12) Patent Application Publication
(10) Pub. No.: US 2006/0062473 A1
(43) Pub. Date: Mar. 23, 2006

(54) Image reading apparatus, image processing apparatus and image forming apparatus

(75) Inventors: Nao Moromizato, Tokyo (JP); Tomohiro Suzuki, Tokyo (JP); Yuji Tamura, Tokyo (JP); Tetsuya Ishikawa, Tokyo (JP); Hiroyasu Nishimura, Tokyo (JP); Tomoya Ogawa, Tokyo (JP); Fumikage Uchida, Asaka-shi (JP); Masayuki Yasukaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/109,039

(22) Filed: Apr. 18, 2005

(30) Foreign Application Priority Data
Sep. 22, 2004 (JP) JP2004-274393

(51) Int. Cl. G06K 9/46

(52) U.S. Cl. 382/190

(57) ABSTRACT

An image reading apparatus comprises a reading section to read an original document having plural pages, and generate plural page data corresponding to the pages, a judging section to determine whether the page data includes at least one of a predetermined character, a predetermined symbol or predetermined attribution information, and an extracting section to extract a page which is determined to include at least one of the predetermined character, the predetermined symbol or the predetermined attribution information by the judging section.

### RELATED APPLICATION

This application claims priority from Japanese Patent Application No. JP2004-274393 filed on Sep. 22, 2004, which is incorporated hereinto by reference.

### BACKGROUND

1. Field of the Invention

The present invention relates to an image reading apparatus, an image processing apparatus, and an image forming apparatus featuring an image extracting function.

2. Description of the Related Art

Up to now, in order to extract and print a target page from documents or images configured as a plurality of pages which are stored in a storage apparatus, it has been necessary to input a page number by a keyboard or extracting a requested image from minimized images displayed as a list.

For example, Japanese Patent Application Open to Public Inspection No. H05-73624 discloses an image information processing apparatus capable of printing a target page by reading and analyzing an image marked on an index sheet. Such index sheet is a sheet including minimized images in plural pages. A user places a mark on the target page to be printed.

Character recognition technology for extracting a specific character in an image has become widely used. For example, Japanese Patent Application Open to Public Inspection No. JP2001-306554 discloses an image processing method and a print processing apparatus which automatically performs character conversion and color conversion of a extracted character string which has been extracted from an image obtained by applying an optically reading operation via the character recognition technology.

In the case of extracting the target image for printing by placing a mark on the printed index sheet including the plural pages of minimized images, since the user has to search for a target page from a number of small images printed on an index sheet, which are difficult to distinguish and to place a mark on it, the workload on the user is increased.

In the apparatus using a character recognition technology, since it just extracts and displays a character string, or modifies an extracted character string, in order to selectively print a page which includes the target character string, the apparatus must confirm the page which includes the extracted character string by the character recognition technology and the user had to specify the page for printing.

### SUMMARY

The present invention was achieved to solve the problems described above and provide an image reading apparatus, an image processing apparatus or an image forming apparatus capable of extracting merely a specific target page from a plurality of pages of documents with less workload on a user.

These and other objects are attained by an image reading apparatus comprises a reading section to read an original document having plural pages, and generate plural page data corresponding to the pages, a judging section to determine whether the page data includes at least one of a predetermined character, a predetermined symbol or predetermined attribution information, and an extracting section to extract a page which is determined to include at least one of the predetermined character, the predetermined symbol or the predetermined attribution information by the judging section.

And the above objects are attained by an image processing apparatus comprises a judging section to determine whether each page data of the plural page data corresponding to the plural pages includes at least one of a predetermined character, a predetermined symbol or a predetermined attribution information, and an extracting section to extract a page which is determined to include at least one of the predetermined character, the predetermined symbol or the predetermined attribution information by the judging section.

And, the above objects are attained by an image forming apparatus comprises a reading section to read an original document having plural pages, and to generate page data corresponding to the plural pages, a printing section to print a page of the plural pages based on the page data, a judging section to determine whether the page data includes at least one of a predetermined character, a predetermined symbol or predetermined attribution information exists in the page data, and an extracting section to extract a page corresponding to the page data includes at least one of the predetermined character, the predetermined symbol and the predetermined attribution information, and outputs the page data corresponding to the page being extracted to the printing section.

Further, the above objects are attained by an image forming apparatus comprises a printing section to print page data, a judging section to determine whether the page data includes at least one of a predetermined character, a predetermined symbol or predetermined attribution information exists in the page data, and an extracting section to extract a page which is determined to include at least one of the predetermined character, the predetermined symbol or the predetermined attribution information by the judging section, and to allow the printing section to print the page data based on the page being extracted.

According to the image reading apparatus, image processing apparatus and image forming apparatus of the present invention, since these apparatuses extract a page including a predetermined a character, a symbol or attribution information from plural pages of a document, an identification process based on a page by page sequence becomes possible at a lowered workload. Since it is not necessary for a user to confirm the page which includes an extracted character string and to conduct an operation to specify the page as the extracting target page, which is different from the case of extracting merely a character string.

The invention itself, together with further objects and attendant advantages, will best be understood by reference to the following detailed description taken in conjunction with the accompanying drawings.

### BRIEF DESCRIPTION OF THE DRAWING

FIG. 1 illustrates a block diagram of an image reading apparatus of the first embodiment of the invention.

FIG. 2 illustrates a front view of an example of a setting section.

FIG. 3 illustrates a flowchart of an operational sequence of an image reading apparatus of the first embodiment of the present invention.

FIG. 4 illustrates a flowchart showing a judging process.

FIG. 5 illustrates an example of extracting a page of order sheet from an account book having a plurality of pages.

FIG. 6 illustrates a network system including an image processing apparatus of the second embodiment of the present invention.

FIG. 7 illustrates a block diagram of a configuration of an image processing apparatus of an embodiment of the present invention.

FIG. 8 illustrates a flowchart of an operational sequence of an image forming apparatus of the second embodiment.

FIG. 9 illustrates a block diagram of an image processing system of the third embodiment of the present invention.

FIG. 10 illustrates a network system including an image processing system of the third embodiment of the present invention.

FIG. 11 illustrates a flowchart of an operational sequence of an image processing system of the third embodiment.

FIG. 12 illustrates a block diagram of the configuration of an image forming apparatus of the fourth embodiment of the present invention.

FIG. 13 illustrates a flowchart of an operational sequence of an image forming apparatus of the fourth embodiment of the present invention.

FIG. 14 illustrates an example of specifying the judging target area.

FIG. 15 illustrates an example of the judging result when adding a character size for judging existence of a character string.

FIG. 16 illustrates a front view of an example of a setting section which adds a limitation of the number of characters to the character string of a judging reference.

### DETAILED DESCRIPTION OF THE PREFERRED EMBODIMENTS

The first embodiment of the preferred embodiments will be described below based on drawings.

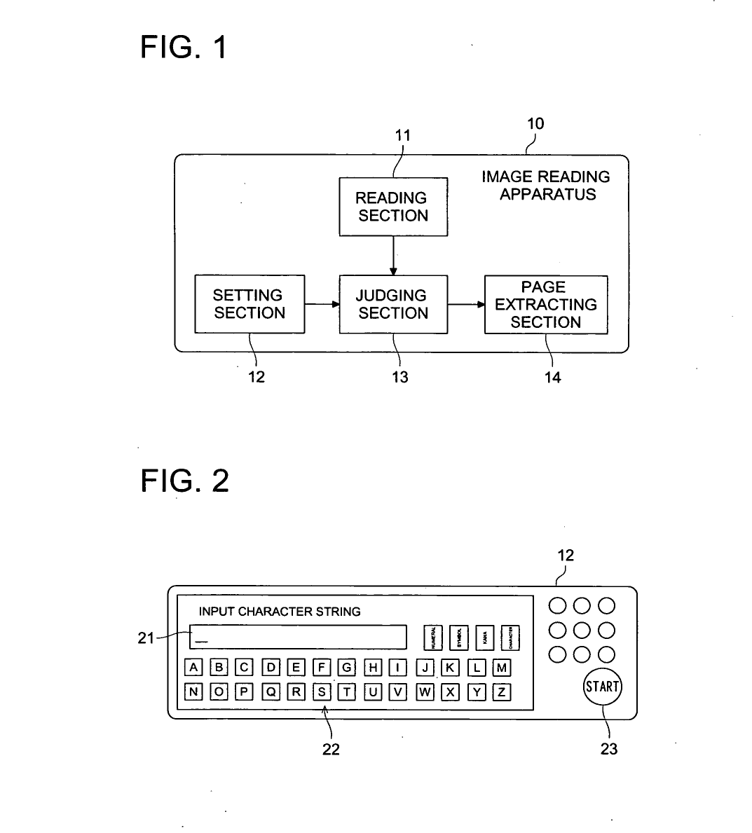

FIG. 1 illustrates a configuration of image reading apparatus 10 of the first embodiment of the preferred embodiments. Image reading apparatus 10 comprises reading section 11 which reads a document, setting section 12 which sets a character string to be used as the judging reference for extracting a page, judging section 13 which determines whether the character string which has been set by setting section 12 is included in each page read and obtained by reading section 11, and extracting section 14 which extracts the page has been determined to include the character string, from among the plural pages read by reading section 11.

Reading section 11 comprises a light source which irradiates a document, a line sensor which reads each line in across the width of the page, a moving device which moves the reading position line by line in the longitudinal direction of the document, and an optical path configured of a lens and a mirror for forming an image by guiding a reflected light from the document into an image sensor. Analog image signals outputted from the line sensor are converted into digital image signals (A/D conversion). Reading section 11 includes an auto document feeder which continuously reads plural document pages sequentially.

Setting section 12, shown in FIG. 2, comprises liquid crystal display 21, several kinds input keys 22 which inputs a character string structured of characters and symbols, and start key 23 to initiate the reading operation. Setting section 12 also functions to display inputted character strings, several other kinds of operation guidance information and operation status information.

Judging section 13 and page extracting section 14 comprise a circuit including a CPU (Central Processing Unit)(not shown), ROM (Read Only Memory) and RAM (Random Access Memory) as a main section. ROM stores programs which CPU executes as well as various kinds of fixed data. RAM functions as a memory for temporarily storing image data read by reading section 11.

Judging section 13 analyses the image data temporarily stored in RAM, described above and conducts character recognition. The character recognition is conducted by a conventional OCR (Optical Character-Recognition) algorithm and a pattern matching process. When continuously reading plural groups of documents (For example, Job A, Job B, etc.,) the judging and extracting processes are conducted for each page of respective jobs.

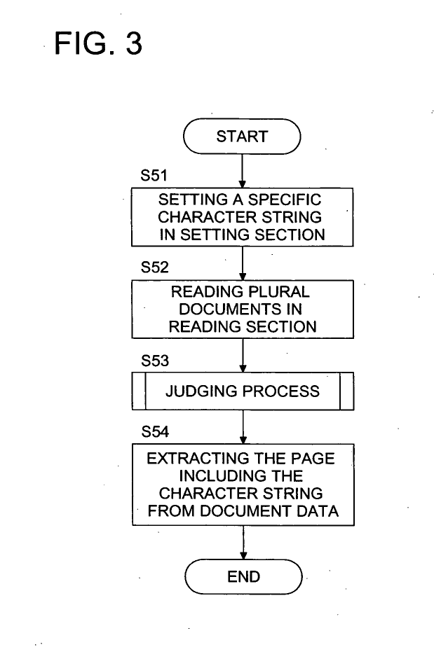

FIG. 3 illustrates an operation flow of image reading apparatus 10. A user can, via setting section 12 (step S51), set a character string which will be a judging reference for extracting a page. When start key 23 is activated, reading section 11 starts to sequentially read plural pages of a document placed on a document table. Image data (page data) obtained by reading the document is temporally stored in a memory. At this time, a management table is created to manage the storage location of the image data in the memory.

Judging section 13 judges whether the character string set by the user is with in the image data of any page which has been read (Step S53). If judging section determines the character string is included, that page, corresponding to the image data which includes the character string, is extracted (Step S54). The handling of extracted image data is designed so that the user can select one of the following options. For example, page extracting section 14 transfers extracted image data to an external apparatus; transfers image data as a file to an external apparatus; prints the image data after the transferring; or stores the image data in external or internal memory. Further, it is also possible that the extracted page based on a judgment that the each page data which includes data corresponding to a predetermined character or predetermined symbol, may be displayed on a display section (not shown) integrated in image reading apparatus 10, or on the display section of a computer (not shown). With regard to the display, it is possible to display the extracted page as a whole page, a part of a page or a minimized index image. When there is limitation with a display section, only the page number of the extracted page may be displayed. The image data which is included in pages which have not been extracted will be deleted. The document pages which have not been extracted may be stored or outputted as distinct pages or differently separated from the extracted pages.

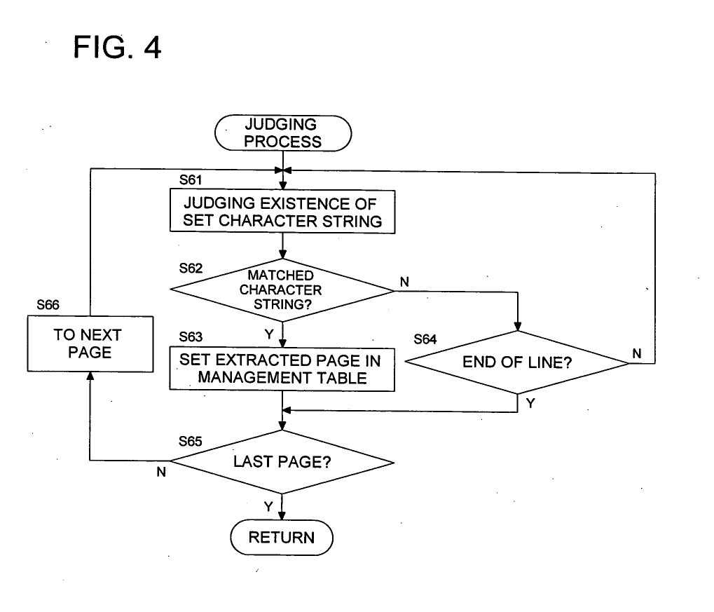

FIG. 4 illustrates a flowchart of a page extracting process. In a judging process, judging section 13 judges whether a set character string is included within a page by checking from the top of the page downward (Step S61). When the existence of the set character string is detected (Step S62; Y), judging section 13 immediately terminates the judging process, and then creates the aforementioned management table which specifies that the page is an objective page which is to be extracted (Step S63). After that, judging section 13 checks to see if the judging process has been conducted on the last page of the plural pages of the document. When the last page has not been processed yet (Step S 65; N), process proceeds to the next page and continues the process (Step S66). If it is the last page (Step S65; Y), judging section terminates the process and returns to the top after the page. Further, in the aforementioned judging process or in the page identification process, when data corresponding to a predetermined character string or a predetermined symbol is detected within a page data, the judging process of the page data is terminated (data residing in the page data after the point where the data has been detected will not be objective data to be processed), and the judging process will proceed to the next page.

Judging section 13 continues the judging process as long as set character string is detected (Step S64; N). When no character string is detected though the last page (Step S64; Y), Judging section 13 checks whether the page is the last page. When it is not the last page (Step S65; N), then judging section 13 processes the next page (Step S66) and terminates the process of the page if it is a last page (Step S65; Y) (Return).

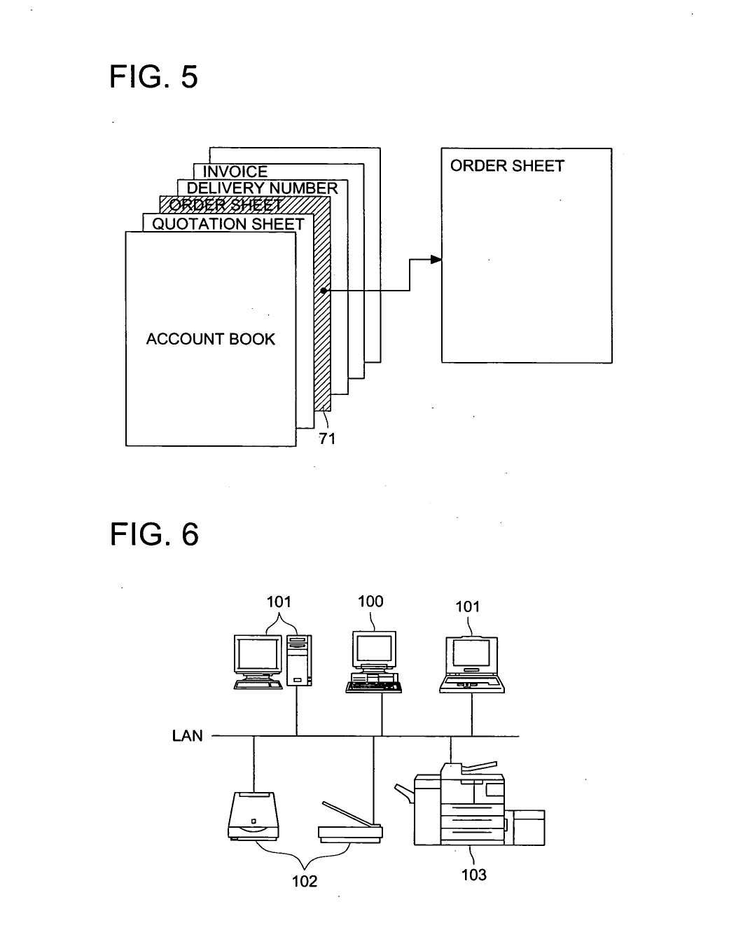

FIG. 5 illustrates an example of a page of an order sheet extracted from a plurality of pages of an account book. A user sets a character string as a character string on the “order sheet” for a judging reference via setting section 12. After that, reading section 11 reads all pages of the account book and the judging section 13 judges whether the character string exists on any of the order sheets. In the example of FIG. 5, if judging section 13 detects the character string of the “order sheet” located within the third page, for example page 71, is set as an extracted and objective page. In FIG. 5, the page showing oblique lines denotes to be extracted page. As described above, it is possible for a user to selectively obtain an order sheet from a plurality of pages of account book by setting a character string (here, it is referred to as “order sheet”) as a judging reference.

Image processing apparatus 100 of the second embodiment of the preferred embodiments will be described below. Image processing apparatus 100 functions to extract a page including the predetermined character string from a plurality of pages of a document. The image processing apparatus comprises a CPU, a ROM, a RAM, a main body having various kinds of interfaces (I/F), a keyboard and a computer all of which function as image processing apparatus 100 which is operated by executing predetermined computer programs.

FIG. 6 illustrates a configuration of a network system including image processing apparatus 100. Image processing apparatus 100 is connected to a LAN (Local Area Network). Information processing apparatus, such as personal computers, etc., scanner 102 and multifunctional copier 103 are connected to the LAN.

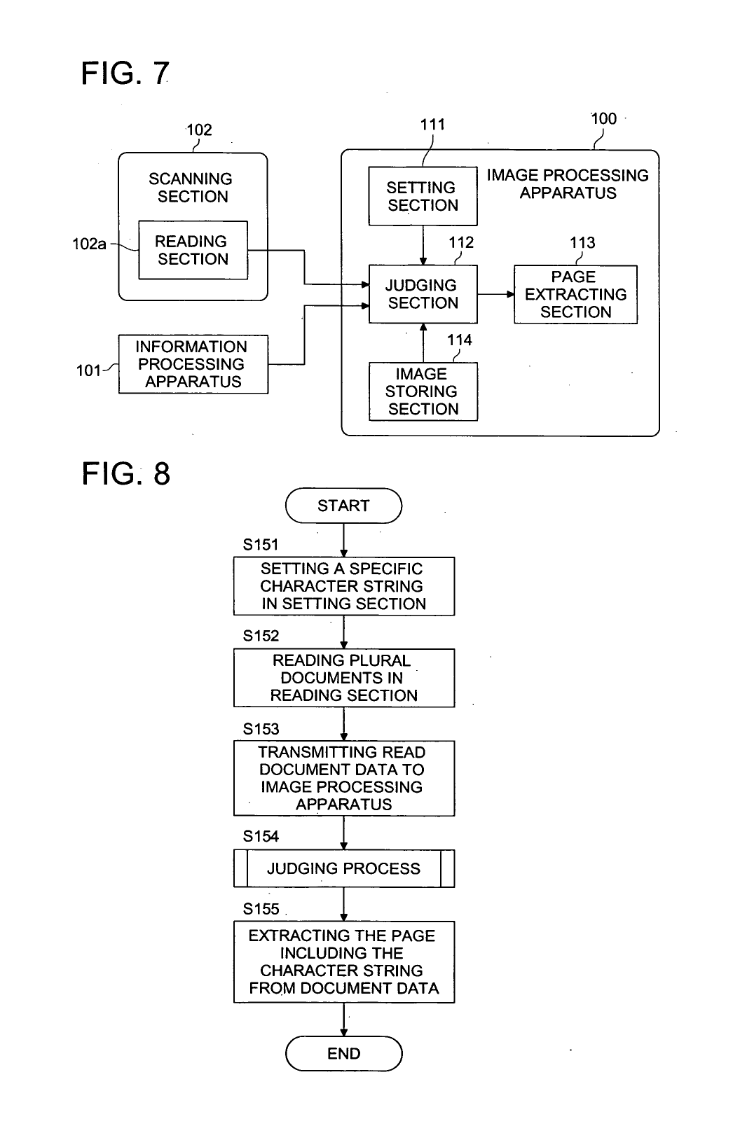

FIG. 7 illustrates a block diagram of the step of image processing apparatus 100. Image processing apparatus 100 comprises setting section 111 which sets a character string which will be the judging reference to extract a page, judging section 112 which determines whether the character string entered via setting section 111 is included in any page of objective documents to be checked and page extracting section 113 to extract a specific page from the plurality of pages of document data when judging section 112 determines that the page carries the specific character string. Other than these, image processing apparatus 100 comprises image storing section 114 which stores document data, a communication section (now shown) and an interface section.

Setting section 111 is structured by a keyboard, a mouse and a display. Instead of setting section 111, the specific character string for the judging reference may be inputted from an external apparatus. As for image storing section 114, a large capacity storage apparatus, such as a hard disk apparatus is preferable.

The document data to be judged by judging section 112 may be inputted via external scanning apparatus 102 and/or information processing apparatus 101 via a LAN. Document data stored in image storing section 114 may be the objective data to be judged. It is also possible that the document data can be inputted or received by using an interface function integrated to image processing apparatus 100. Here, reading section 102a of scanning apparatus 102 is the same configuration of reading section 11 of image reading apparatus 10. The document data includes image data as image information and printed data denoting the contents of the document by a code, such as character code. Image storing section 114 may be provided outside of image processing apparatus 100 and connected to image processing apparatus 100.

FIG. 8 illustrates a flowchart of an operation of image processing apparatus 100. Here, image data inputted from scanning apparatus 102 is treated as document data. A character string which will be the judging reference for page extraction is set by a user via setting section of image processing apparatus 100 (Step S151). When the user operates a start key after setting the document of scanning apparatus 102, the plurality of pages of documents is read by scanning apparatus 102 (Step S152). Scanning apparatus transfers the image data obtained by scanning to image processing apparatus 100 (Step S153).

Image processing apparatus 100 receives the image data sent from scanning apparatus 102, and temporally stores the image data to image storing section 114 and/or other memory. At this time, a management table is created to manage a storing location of the image data in the memory.

Judging section 112 determines whether image data of each page stored in the memory includes the character string set by the user (Step S154) and extracts the page which is determined that the page data corresponding to the page includes the character string (Step S155). The handing of extracted pages is designed either being fixedly set or being extracted by the user as following. For example, image data in the extracted page is stored as it is; stored as a file; transferred to an external apparatus and/or requested to be printed by an external printing apparatus. Further, it is also possible that the extracted page based on a determination that the each page data which includes data corresponding to a predetermined character or a predetermined symbol, may be displayed on a display section (not shown) incorporated in image reading apparatus 100 or a display section of image processing apparatus 101 connected to image reading apparatus 100. With regard to the display, it may be possible to display the extracted page, the whole page, a part of the page or a minimized index image. When there is limitation with a display section, only the page number of the extracted page may be displayed.

Non-extracted pages of document data are deleted. The non-extracted pages of document data may be configured so as to be stored or outputted separately from extracted pages. When the document data is coded data, the presence of the character string is checked by the accordance of the code data.

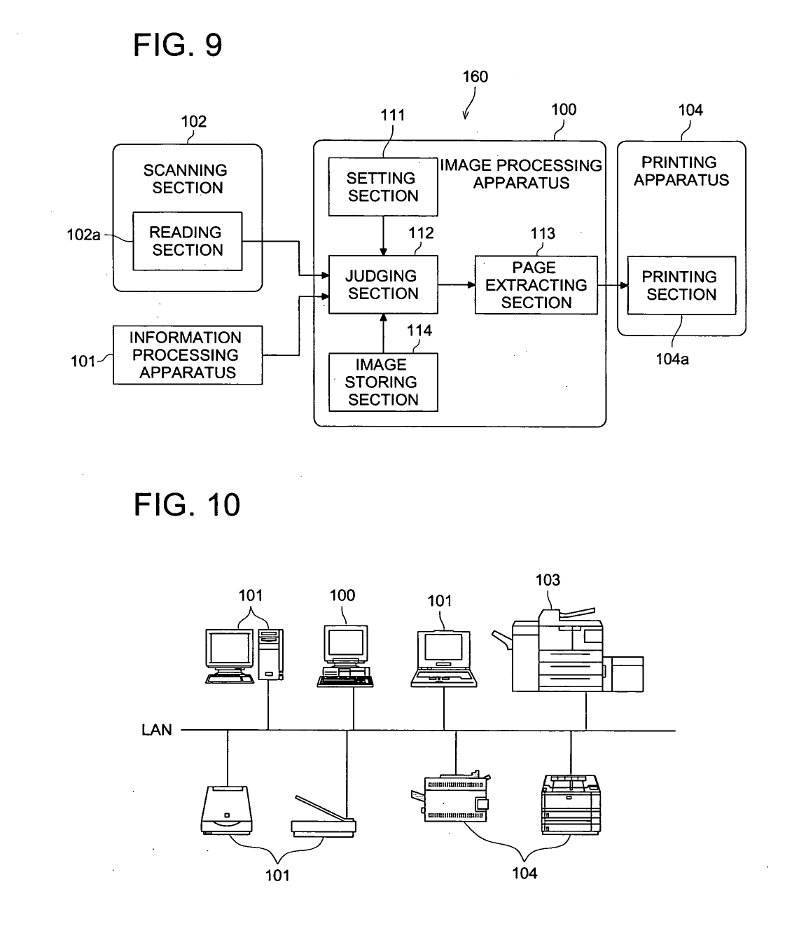

Image processing system 160 of the third embodiment of the preferred embodiments will be explained below. Image processing system 160 shown in FIG. 9 is a system, which comprises a system shown in FIG. 7 and printing apparatus 104. Since the same number, letters and reference characters are placed on the same portion shown in FIG. 7, the explanation for those portions are not recited. As shown in the second embodiment of the preferred embodiments, image storing section 114 may be placed outside of image processing apparatus 100 and connected to image processing apparatus 100.

Printing apparatus 104 forms and outputs images corresponding to inputted image data or printing data, onto a recording paper sheet by electronic photo processing. Printing apparatus 104 is configured as a laser beam printer, which comprises a conveying apparatus of recording paper sheets, a photosensitive drum, an electro-charger, a laser unit, a developing apparatus, a transferring/separating apparatus, a cleaning apparatus and a fixing apparatus as an engine section.

FIG. 10 illustrates a network system including an image processing system 160. Comparing with FIG. 6, printing apparatus 104 is additionally connected to a LAN.

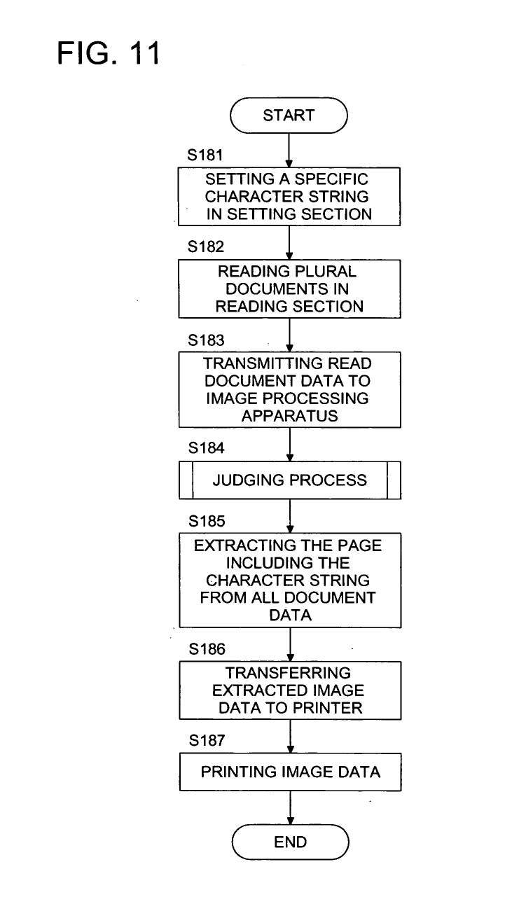

FIG. 11 illustrates a flowchart of an operational sequence of an image processing system 160. Here, a case that image data is inputted from scanning apparatus 102 as document data and the extracted pages are printed via printing apparatus 104, will be described. Since, a series of process from the beginning to the point where the extracted pages are extracted (from Step S181 to Step S185) is the same from step S151 to step S155 shown in FIG. 6, the explanation will not be recited.

In image processing apparatus 100, page extracting section 113 transfers image data of extracted page to printing apparatus via a LAN (Step S186). Printing apparatus 104 prints and outputs the image corresponding to the image data transmitted from image processing apparatus 100(Step S187).

With regard to how to handle the image data, the image data may be printed out; stored as it is; stored as a file; or transferred to an external apparatus, such as management server.

Non-extracted pages of document data are deleted. The non-extracted pages of document data may be configured so as to be stored or outputted separately from extracted pages.

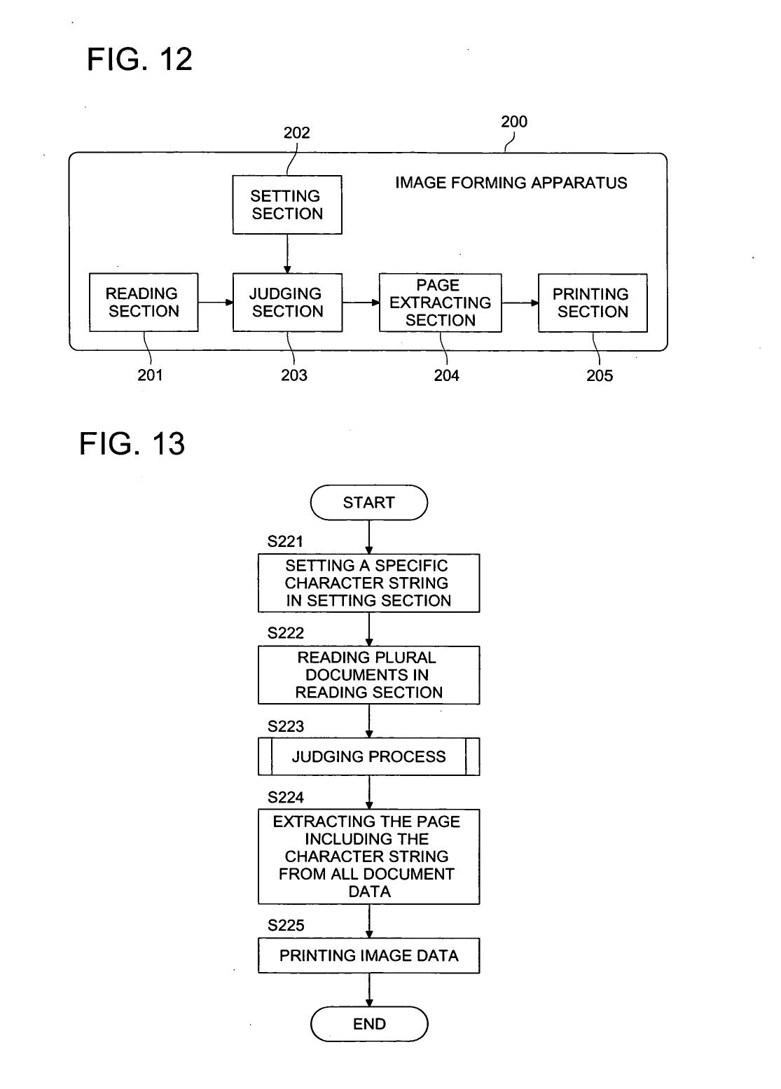

Image forming system 200 of the fourth embodiment of the preferred embodiments will be explained. FIG. 12 illustrates a block diagram of image forming apparatus 200. Image forming apparatus 200 comprises reading section 201 which reads document, setting section 202 which sets a character string as a judging reference of page identification, judging section 203 which judges whether the character string set in an image of each page read and obtained via setting section 202, extracting section 204 which extracts a page determined to include the character string by judging section 203, from a plural pages read by reading-section 201. Page extracting section 204 is designed so as to output page data determined to include data corresponding to a predetermined character and/or a predetermined symbol to printing section 205 provided in image forming apparatus 200, and printing section 205 is arranged to receive the page data and print them out.

Since reading section 201 is the substantially same as reading section 11 of image reading apparatus 10; setting section 202 is the substantially same as setting section 12 of image reading apparatus 10; judging section 203 is the substantially same as judging section 13 of image reading apparatus 10; page extracting section 204 is the substantially same as page extracting section 14 of image reading apparatus 10; and printing section 205 is the substantially same as printing section 104a of printing apparatus 104 shown in FIG. 9, description of each section will be eliminated here. Image forming apparatus 200 comprises a facsimile function, a printing function and a scanning function, etc., in addition to the function as a copier for forming a copy after reading a document. In the example described above, it is described that image forming apparatus 200 comprises reading section 201. However, it is needless to say that an image forming apparatus may be a printer, which does not include a reading section therein.

FIG. 13 illustrates a flowchart of an operational sequence of an image forming apparatus 200. A user conducts an extracting mode setting through setting section 202. After setting the extracting mode, the user sets a character string which will be a judging reference of page identification through setting section 202 (Step S221). When the user operates a start key, reading section 201 starts reading plural documents set on a document table (Step S222). Image data of each page read and obtained by reading the documents is temporally stored in a memory. At this time, a management table to manage the storing location of the image data in the memory is created.

Judging section 203 judges whether the character string, which a user has set, exits in the image data of each page read by reading section 201 (Step S223). Page extracting section 204 extracts the page which, is determined by judging section 203 to include the above mentioned character string (Step S224), and printing section 205 prints out the page extracted by page extracting section 204 (Step S225). The image data of the extracted page is deleted after printing is completed. Non-extracted image data is deleted before printing or after the printing together with the extracted image data.

While the preferred embodiments have been shown and described, it is to be understood that these disclosure are for the purpose of illustration and various changes and modifications may be made without departing from the scope of the invention as set forth in the appended claims. For example, in the embodiment, the existence of the set character string is check across the whole area of a page, however it may be a specific area in the page. Namely, once, a tile, such as “order sheet” is determined, it may be appeared in a specific portion of the order sheet. Accordingly, the process load for the judgment and a processing time may be minimized by limiting the judging area.

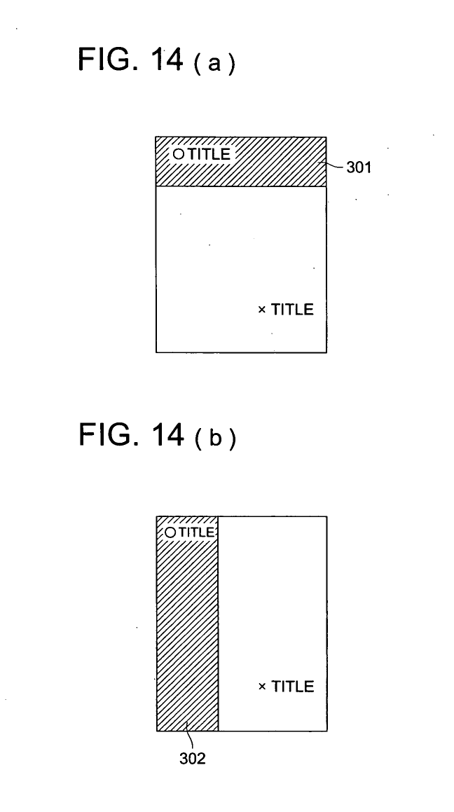

FIG. 14(a) illustrates an example which sets the judging area 301 on the upper portion of the page. FIG. 14(b) illustrates an example which sets the judging area 301 on the left portion of the page. Setting the judging area can be conducted through setting section of image reading apparatus 10, image processing apparatus 100 or other operational panels. In FIGS. 14(a) and 14(b), a circle mark shows that mark is found and a x-mark shows that the mark does not found, because they are not in the judging area 301.

With regard to judging reference, various additional conditions, such as attribution data may be set. For example, in many cases, the title of the document is arranged to be different from others in order to differentiate it from others by changing a character size, font and putting special decoration. In order to extract those character strings, the additional conditions, such as character size (attribution data) may be added to the detecting conditions.

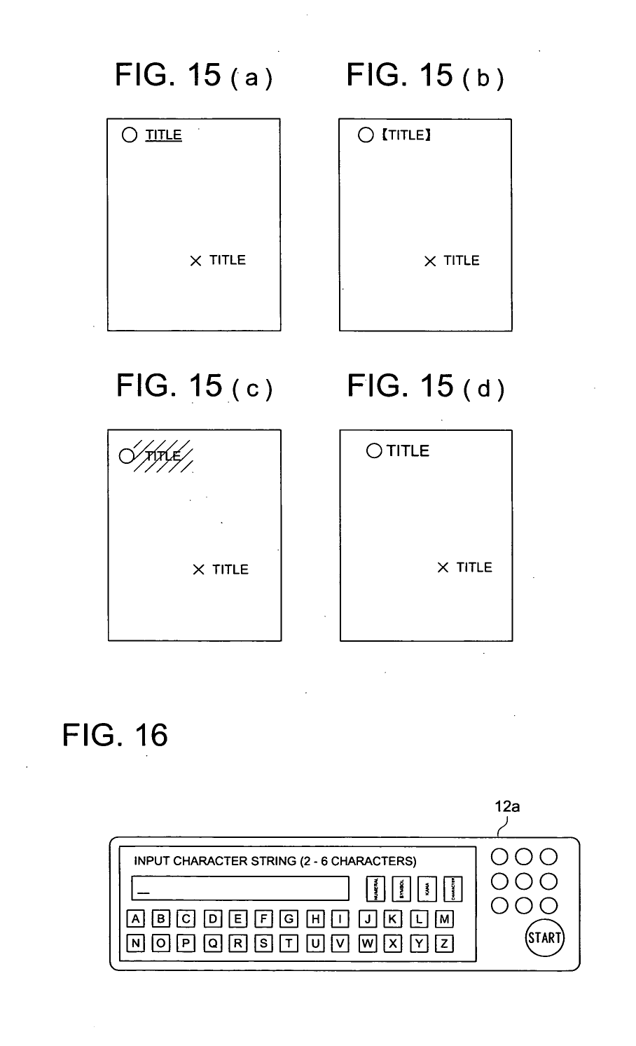

FIG. 15(a) shows an example of a tile with a under line. FIG. 15(b) shows an example of a title with parentheses. FIG. 15(c) shows and example of a tile covered by mesh. FIG. 15(d) shows an example of a character having 12-point. The attribution data, such as the underline, parentheses, mesh and character size are added to the judging condition. Although a character strings is “TITLE”, with a circular mark in FIGS. 14(a)-14(d) is found, a character string with x-marked is not found even though the character sting matches the reference condition. Since attribution data does not match to the additional condition.

Only additional condition (attribution data), such as character size and existence of decoration may be used as a judging reference. For example, extracting a character string having more than a 30-point.

The maximum number of the characters and/or minimum number of characters may be set in order to improve the detecting accuracy of a character string and prevent misdetection of an unintended character string. FIG. 16 illustrates an example of setting section 12a when limiting the number of characters of a character string for judging reference. An operational guide that the number of characters which can be set is limited to two to six is displayed on the surface of setting section 12a.

In the embodiments described above, the page corresponding to the page data including the set character string is arranged to be extracted. However it is possible that the page corresponding to the page data not including the set character string is arranged to be extracted. In any case, it may be allowed that each page data is checked whether it includes at least one of a predetermined character, a predetermined symbol and predetermined attribution information and the page corresponding to the page data which matches the judging reference based on the judgment described above, is extracted. Further, it is allowed to selectively extract the pages including the set character string and other pages. For example, Pages corresponding to the page data including the set character string and other pages corresponding to the page data which do not include the set character string are stored as respective files in the memory. With regard to non-extracted page, the user can select a handling method of image data in the non-extracted page. For example, it may be deleted; stored as a file separately from extracted pages; separately printed out from extracted pages; or separately transferred from extracted pages. In the embodiments described above, explained is an example which extracts a page by judging whether each page data corresponding to each page includes any one of a predetermined character, a predetermined symbol or predetermined attribution information, page by page. And when it matches the criteria, for example, predetermined character is included or predetermined no predetermined symbol is included, all pages matching the criteria are extracted. However, the present invention is not limited to this embodiment. Namely, it is allowed that the judging process is stopped to extract the page as soon as the page data which matches the detecting condition, that any one of predetermined character, predetermined symbol or predetermined attribution information is detected in a page in each page data to be retrieved. The present invention is not limited to the embodiment described above. Namely, in the case that when page data which matches the retrieve condition that one of a predetermined character, a predetermined symbol or predetermined attribution information is found in each page to be retrieved, the judging process is stopped and the page may be extracted.

In the embodiment described above, it is described that when generating each page data based on a plurality of pages of a document, the judging process may be started after having generated page data corresponding to all pages. However, it is not limited to this embodiment. Namely, it is possible that judging process and extracting process may be started after reading documents having plural pages but before generating page data corresponding to all pages the document having plural pages.

In the case of double sided documents, it is possible that when a predetermined character is detected at least in either side of the document, both pages are extracted. In this case it is preferable to make it selectable that setting that both pages are extracted or only the page where the said character string exists is extracted.

It is also possible that plural judging references can be set and plural kind pages are extracted based on respective judging references. For example, when character string A and character string B are set as judging references, a page corresponding to page data including the character string A may be extracted as group A and a page corresponding to page data including the character B may be extracted as group B. It becomes possible to extract plural pages classified into plural classes based on one reading operation.

What is claimed is:

1. An image reading apparatus comprising:
a reading section which reads an original document having plural pages, and generates plural page data corresponding to the pages;
a judging section which determines whether the page data includes at least one of a predetermined character, a predetermined symbol and predetermined attribution information; and
an extracting section which extracts a page corresponding to a page data which is determined to include at least one of the predetermined character, the predetermined symbol and the predetermined attribution information by the judging section.

2. The image reading apparatus of claim 1, further comprising:
a setting section which sets at least one of the predetermined character, the predetermined symbol and the predetermined attribution information.

3. The image reading apparatus of claim 1,
wherein first time when the judging section determines a page data includes at least one of the predetermined character, the predetermined symbol and the predetermined attribution information, the judging section shifts a target page to be determined to another page.

4. The image data reading apparatus of claim 1, further comprising:
a display section,
wherein the extracting section allows the display section to display the page being extracted based on the page data which is determined to include at least one of the predetermined character, the predetermined symbol and the predetermined attribution information on the display section.

5. The image reading apparatus of claim 1,
wherein the image reading apparatus is connected to an external display device and the extracting section allows the external display device to display the page being extracted based on the page data which is determined to include at least one of the predetermined character, the predetermined symbol and the predetermined attribution information on the external display device.

6. The image reading apparatus of claim 1,
wherein the extracting section outputs the page data corresponding to the page being extracted to outside of the image reading apparatus.

7. The image reading apparatus of claim 1,
wherein the extracting section creates a file based on the page data corresponding to the page being extracted.

8. The image reading apparatus of claim 7,
wherein the image reading apparatus stores the file.

9. The image reading apparatus of claim 7,
wherein the image reading apparatus outputs the file to outside of the image reading apparatus.

10. The image reading apparatus of claim 1,
wherein, the extracting section extracts a first page corresponding to a first page data which is determined to include at least one of the predetermined character, the predetermined symbol and the predetermined attribution information, and a second page corresponding to a second page data which is determined not to include any one of the predetermined character, the predetermined symbol and the predetermined attribution information.

11. An image processing apparatus comprising:
a judging section which determines whether each page data of the plural page data corresponding to the plural pages includes at least one of a predetermined character, a predetermined symbol and a predetermined attribution information; and
an extracting section which extracts a page corresponding to a page data which is determined to include at least one of the predetermined character, the predetermined symbol and the predetermined attribution information by the judging section.

12. The image processing apparatus of claim 11, further comprising:
a setting section which sets at least one of the predetermined character, the predetermined symbol and the predetermined attribution information.

13. The image processing apparatus of claim 11,
wherein first time when the judging section determines a page data includes at least one of the predetermined character, the predetermined symbol and the predetermined attribution information, the judging section shifts a target page to be determined to another page.

14. The image processing apparatus of claim 11, further comprising:
a display section,
wherein the extracting section allows the display section to display the page being extracted based on the paged data which is determined to include at least one of the predetermined character, the predetermined symbol and the predetermined attribution information on the display section.

15. The image processing apparatus of claim 11, wherein the image processing apparatus is connected to an external display device and the extracting section allows the display section to display the page being extracted based on the page data which is determined to include at least one of the predetermined character, the predetermined symbol and the predetermined attribution information on the external display device.

16. The image processing apparatus of claim 11,
wherein the extracting section outputs the page data corresponding to the page being extracted to outside of the image processing apparatus.

17. The image processing apparatus of claim 11,
wherein the extracting section creates a file based on the page data corresponding to the page being extracted.

18. The image processing apparatus of claim 17,
wherein the image processing apparatus stores the file.

19. The image processing apparatus of claim 17,
wherein the image processing apparatus outputs the file to outside of the image processing apparatus.

20. The image processing apparatus of claim 11,
wherein the page data is obtained from outside of the image processing apparatus.

21. The image processing apparatus of claim 20,
wherein the page data is obtained from outside of the image processing apparatus from a scanner connected to the image processing apparatus.

22. The image processing apparatus of claim 20,
wherein the page data is obtained from a storage device connected to the image processing apparatus.

23. The image processing apparatus of claim 11,
wherein, the extracting section extracts a first page corresponding to a first page data which is determined to includes at least one of the predetermined character, the predetermined symbol and the predetermined attribution information, and a second page corresponding to a second page data which is determined not to include any one of the predetermined character, the predetermined symbol and the predetermined attribution information.

24. An image forming apparatus comprising:
a reading section which reads an original document having plural pages, and generates page data corresponding to the plural pages;
a printing section which prints a page of the plural pages based on the page data;
a judging section which determines whether the page data includes at least one of a predetermined character, a predetermined symbol and predetermined attribution information exists in the page data; and
an extracting section which extracts a page corresponding to the page data which is determined to include at least one of the predetermined character, the predetermined symbol and the predetermined attribution information, and outputs the page data corresponding to the page being extracted to the printing section.

25. The image forming apparatus of claim 24, further comprising:
a setting section which sets at least one of the predetermined character, the predetermined symbol and the predetermined attribution information.

26. The image forming apparatus of claim 24,
wherein first time when the judging section determines a page data includes at least one of the predetermined character, the predetermined symbol and the predetermined attribution information, the judging section shifts a target page to be determined to a another page.

27. The image forming apparatus of claim 24, further comprising:
a display section;
wherein the extracting section allows the display section to display the page being extracted based on the page data which is determined to include at least one of the predetermined character, the predetermined symbol and the predetermined attribution information on the display section.

28. The image forming apparatus of claim 24
wherein the image forming apparatus is connected to an external display device and the extracting section allows the external display section to display the page being extracted based on the page data which is determined to include at least one of the predetermined character, the predetermined symbol and the predetermined attribution information on the external display.

29. The image forming apparatus of claim 24,
wherein the extracting section outputs the page data corresponding to the page being extracted to outside of the image forming apparatus.

30. The image forming apparatus of claim 24,
wherein the extracting section creates a file based on the page data corresponding to the page being extracted.

31. The image forming apparatus of claim 30,
wherein the image forming apparatus stores the file.

32. The image forming apparatus of claim 30,
wherein the image forming apparatus outputs the file to outside of the image forming apparatus.

33. The image forming apparatus of claim 24,
wherein the page data is obtained from outside of the image forming apparatus.

34. The image forming apparatus of claim 33,
wherein the page data is obtained from a scanner device connected to the image forming apparatus.

35. The image forming apparatus of claim 33,
wherein the page data is obtained from a storage device connected to the image forming apparatus.

36. The image forming apparatus of claim 24,
wherein, the extracting section extracts a first page corresponding to a first page data which is determined to includes at least one of the predetermined character, the predetermined symbol and the predetermined attribution information, and a second page corresponding to a second page data which is determined not to include any one of the predetermined character, the predetermined symbol and the predetermined attribution information.

37. An image forming apparatus comprising:
a printing section which prints page data;
a judging section which determines whether the page data includes at least one of a predetermined character, a predetermined symbol and predetermined attribution information exists in the page data; and
an extracting section which extracts a page corresponding to the page data which is determined to include at least one of the predetermined character, the predetermined symbol and the predetermined attribution information, and outputs the page data corresponding to the page being extracted to the printing section.

38. The image forming apparatus of claim 37, further comprising:
a setting section which sets at least one of the predetermined character, the predetermined symbol and the predetermined attribution information.

39. The image forming apparatus of claim 37,
wherein first time when the judging section determines a page data includes at least one of the predetermined character, the predetermined symbol and the predetermined attribution information, the judging section shifts a target page to be determined to a another page.

40. The image forming apparatus of claim 37, further comprising:
a display section,
wherein the extracting section allows the display section to display the page being extracted based on the page data which is determined to include at least one of the predetermined character, the predetermined symbol and the predetermined attribution information on the display section.

41. The image forming apparatus of claim 37,
wherein the image forming apparatus is connected to an external display device and the extracting section allows the external display section to display the page being extracted based on the page data which is determined to include at least one of the predetermined character, the predetermined symbol and the predetermined attribution information on the external display.

42. The image forming apparatus of claim 37,
wherein the extracting section outputs the page data corresponding to the page being extracted to outside of the image forming apparatus.

43. The image forming apparatus of claim 37,
wherein the extracting section creates a file based on the page data corresponding to the page being extracted.

44. The image forming apparatus of claim 43,
wherein the image forming apparatus stores the file.

45. The image forming apparatus of claim 43,
wherein the image forming apparatus outputs the file to outside of the image forming apparatus.

46. The image forming apparatus of claim 37,
wherein the page data is obtained from outside of the image forming apparatus.

47. The image forming apparatus of claim 46,
wherein the page data is obtained from a scanner device connected to the image forming apparatus.

48. The image forming apparatus of claim 46,
wherein the page data is obtained from a storage device connected to the image forming apparatus.

49. The image forming apparatus of claim 37,
wherein, the extracting section extracts a first page corresponding to a first page data which is determined to includes at least one of the predetermined character, the predetermined symbol and the predetermined attribution information, and a second page corresponding to a second page data which is determined not to include any one of the predetermined character, the predetermined symbol and the predetermined attribution information.
